(19) United States
(12) Patent Application Publication
(10) Pub. No.: US 2010/0170154 A1
(43) Pub. Date: Jul. 8, 2010

(54) Stable flowerpot system

(76) Inventor: Byoungha Ahn, Hamden, CT (US)

Correspondence Address: Byoungha Ahn, E5, 2420 Whitney Ave., Hamden, CT, 06518, US

(21) Appl. No.: 12/319,313

(22) Filed: Jan. 5, 2009

(51) Int. Cl. A47G 7/02; A01G 9/04

(52) U.S. Cl. 47/71; 47/65.5; 47/72

(57) ABSTRACT

A stable flowerpot system for holding at least one plant comprising a pot supporter (22), a corresponding pot (23), and a corresponding saucer (24). The pot supporter comprises a hollow shell (22D) whose bottom portion is significantly broader than the top portion of the shell. The top portion of the shell extends in-and-downwardly into the interior region of the hollow shell (22D) to form a pot receiver (22C) into which the corresponding pot (23) is removably secured. The corresponding saucer (24) is removably secured in the predetermined position in the interior region of the shell (22D) by a plurality of saucer-holders (22F) formed on the wall of the shell (22D). The stable flowerpot system further includes a decorative skirt (26) to be clad on the outside of the shell (22D) of the pot supporter (22) and a cushion (27) to be placed under the pot supporter (22) for the decoration of the pot (23) being held in the pot supporter (22).

### FIELD OF THE INVENTION

This invention relates to a flowerpot assembly that will avoid falling or toppling over.

### BACKGROUND OF THE INVENTION

Most conventional flowerpots of top-broad-and-bottom-narrow shape may fall or tip over, especially when small to medium-sized pots contain top-heavy or unbalanced plants. For example, most orchid pots of small to medium size with a light medium (soil) may fall over easily, even at the slightest push or jerk. When a pot topples over, the plant in the pot may experience damage to its flowers, buds, leaves, or other parts of the plant, and loss of pot medium. Such damage results in loss of time, labor, and money.

Many nurseries and retail establishments use trays, such as or similar to U.S. Pat. No. 4,684,013 to Paul J. Jacobs (1987), and U.S. Pat. No. 6,453,613 to Jeffrey J. Gratz (2002), that are configured to hold a plurality of small to medium sized pots. Such trays do prevent individual pots from falling over. Although such a tray is suitable for use in large-scale horticulture and the mass transportation of plants, it is not convenient for most home gardeners or hobbyists who deal mostly with individual pots.

Even if a plant is perfectly balanced at the time of purchase, it may grow off balance overtime. Gardeners usually correct the postures of plants by pruning or tying plant parts by using rope or wire. But such a method is not applicable to all kinds of plants. For example, many kinds of orchids, cacti, and other succulent plants have thick and stiff leaves and stems so that conventional remedies are not easy to apply. People usually place their pots in other bigger pots or baskets or similar devices to reduce the chances of the pots' falling over. But these are not perfect solutions. We need better solutions. On the other hand, the unbalanced growth or posture of a plant itself can be the element of esthetical asset of the plant as long as the plant is secured in a pot that is configured not to fall.

The function of a flowerpot is not only to hold a plant (or plants) and medium but also to embellish the plant in the pot. Therefore, many customers purchase pots that are made of expensive material or costly design, or they use pot wrappers for the embellishment of their pots in the formal or informal display of the pots. But most pots or pot wrappers are usually of one-time use and then are disposed of, which is a waste of material and money.

Some prior inventions, such as U.S. Pat. No. 4,014,506 to Jack D. Hanson (1977), U.S. Pat. No. 4,969,618 to Steve Thompson (1990), U.S. Pat. No. 5,103,587 to Josef Holler (1992), U.S. Pat. No. 6,412,740 to Milagros Rush and Gary Rush (2002), U.S. Pat. No. 6,782,659 to Guy Victor Van Laere (2004), U.S. Pat. No. 7,296,379 to James A. Peter (2007), and JP10211072A2 to Kagoshima Iwao (1998), do provide support and various degrees of stability to flowerpots. But compared to these, the stable flowerpot system of the present invention is unique in structure, relatively simple in use, and excellent in providing stability and decorative effect to flowerpots, as illustrated in the ensuing description and drawings.

### SUMMARY OF THE INVENTION

A stable flowerpot system of the present invention comprises a pot supporter, a corresponding pot, and a corresponding saucer. The pot supporter comprises a hollow shell whose bottom portion is significantly broader than the top portion of the shell. The top portion of the shell extends in-and-downwardly into the interior region of the shell to form a pot receiver into which the corresponding pot is removably secured. The corresponding saucer is removably secured in a predetermined position in the interior region of the shell by a plurality of saucer-holding devices formed on the wall of the shell. The stable flowerpot system further includes a decorative skirt that is configured to be clad on the outside of the shell of the pot supporter. The stable flowerpot system further includes a pot-supporter cushion to be placed under the pot supporter for the embellishment of the pot being held in the pot supporter.

### BRIEF DESCRIPTION OF THE DRAWINGS

In the drawings, closely related figures or parts have the same numbers but different alphabetic suffixes. The drawings do not represent the exact proportions or dimensions of the parts of the invention.

FIG. 1 is a cross-sectional view of a stable flowerpot system showing a pot supporter (22), a corresponding pot (23), and a corresponding saucer (24).

FIG. 2 is an elevational view of the stable flowerpot system shown in FIG. 1.

FIG. 3 is an exploded view of the stable flowerpot system shown in FIG. 1.

FIG. 4 is a partial, cross-sectional, perspective view of the pot supporter shown in FIG. 3.

FIG. 5 is a top view of the pot supporter shown in FIG. 3.

FIG. 6 is an enlarged, partial, cross-sectional, elevational view of the pot supporter and the pot shown in FIG. 1.

FIG. 7 is an enlarged, partial, cross-sectional, perspective view of the pot supporter shown in FIG. 4.

FIG. 8 is an enlarged view of the aeration hole (22E) and saucer holder (22F) shown in FIG. 2.

FIG. 9A is an elevational, outside view of the saucer holder shown in FIG. 8.

FIG. 9B is a side view, in cross section, of the saucer holder shown in FIG. 9A.

FIG. 9C is the inside view of the saucer holder shown in FIG. 9A.

FIG. 10 is an elevational view, partially in cross section, illustrating how to separate a saucer (24) from a saucer holder using a finger.

FIG. 11 is a partial, perspective view illustrating how the saucer is horizontally secured by three saucer holders.

FIG. 12 is an illustration showing how to pull out the lower portion of a saucer holder to separate the saucer (not shown) from the saucer holder.

FIGS. 13A to 13C are elevational views of the pot supporters in accordance with three different embodiments of the present invention.

FIGS. 14A to 14C are the perspective views of decorative pot-supporter skirts in accordance with three different embodiments of the present invention with FIG. 14C showing a pot-supporter cushion (27).

FIG. 15 is a partial, inside view of the decorative skirt shown in FIG. 14A.

FIG. 16 is a partial, enlarged view of the lower, inside view of the decorative skirt (26), shown in FIG. 15.

FIG. 17 is a partial, enlarged, inside view of the shell (22D) showing how a skirt-holding eye (26G) of the decorative skirt is hooked to a skirt holder (22U).

FIG. 18 is an elevational view illustrating the method of removing a pot from the pot supporter using another pot (not numbered) in upside-down position.

FIG. 19A is a perspective view showing how parts of the pot-supporter skirt shown in FIG. 14A are assembled.

FIGS. 19B and 19C are partial, enlarged, perspective views of the pot-supporter skirt shown in FIG. 19A.

### DETAILED DESCRIPTION OF THE INVENTION

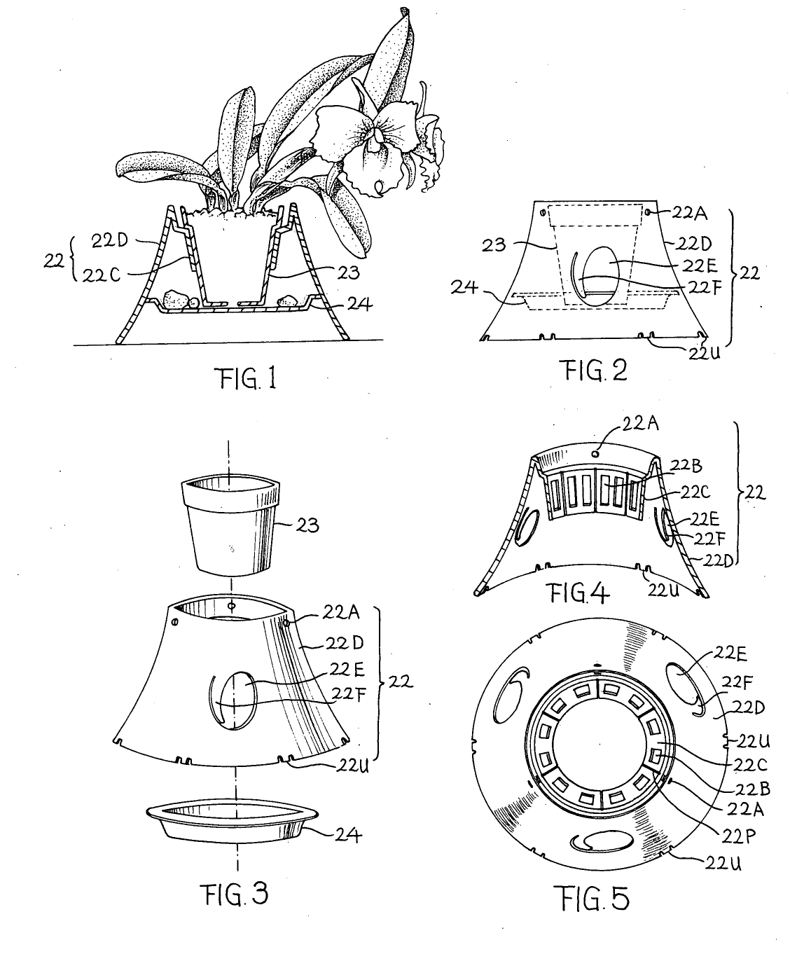

Referring to FIGS. 1 and 3, the stable flowerpot system of the present invention comprises pot supporter 22, corresponding pot 23, and corresponding saucer 24. Referring to FIGS. 14A to 14C, the stable flowerpot system further includes pot-supporter skirt 26 (26′, 26″) and pot-supporter cushion 27 (FIG. 14C). Parts of each of these components will be discussed in detail in the ensuing description.

Referring to FIGS. 1 to 3, pot supporter 22 has hollow shell 22D whose bottom portion is significantly broader than the top portion of the shell so as to provide sufficient stability to pot 23 being held in pot receiver 22C.

Referring to FIGS. 4 to 7, the top portion of shell 22D extends in-and-downwardly into the interior region of shell 22D to form pot receiver 22C of predetermined shape and dimension so as to be able to receive corresponding pot 23 of predetermined shape and dimension.

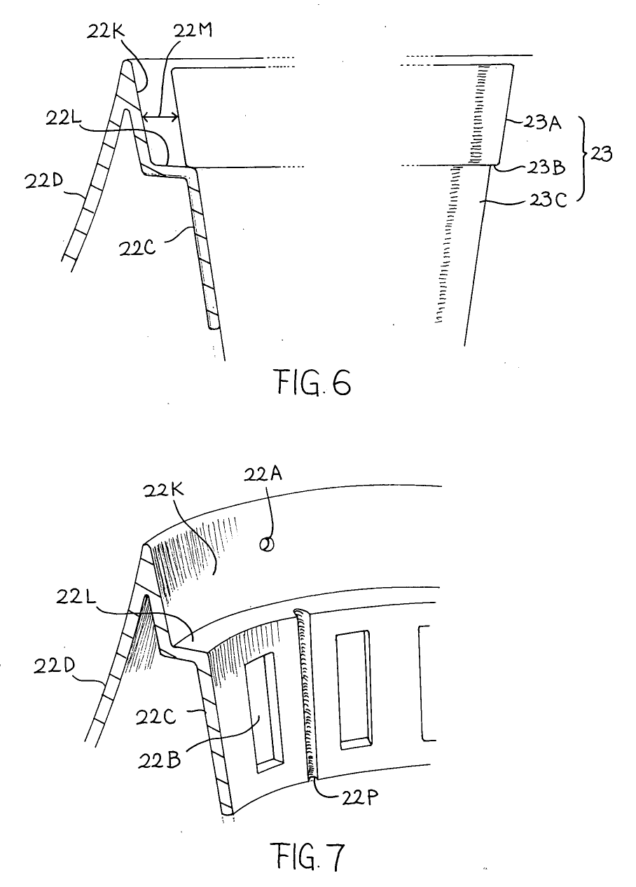

Referring to FIGS. 1 and 6, pot receiver 22C is of sleeve shape with no bottom thereof so that receiver 22C holds the side of pot 23 rather than the bottom of pot 23. The vertical depth of pot receiver 22C is about one half the depth of pot 23. In other embodiments, pot receiver 22C has a bottom (not shown) thereon so that the bottom of pot 23 sits on the bottom of the pot receiver. In the latter case, the bottom of the pot receiver has one or more drain holes of any number, shape, and dimension thereon.

Referring to FIGS. 4, 5 and 7, pot receiver 22C has a plurality of longitudinal openings or slits 22B formed on the wall of pot receiver 22C. Slit 22B is of longitudinal rectangular shape with square corners or rounded corners (not shown in drawings), and the number of slits is twelve, as shown in FIG. 5. But in other embodiments, the shape and the number of slits 22B can vary, or there may no slits at all on pot receiver 22C.

Referring to FIGS. 5 and 7, pot receiver 22C has a plurality of longitudinal drain grooves 22P on the inside surface of pot receiver 22C. The number of grooves 22P is six, and the width of groove 22P is about 3 mm. But the number and the dimension of grooves 22P can vary in other embodiments.

Referring to FIG. 7, the upper portion of drain groove 22P is extended a little bit onto the upper surface of terrace 22L so that the upper portion of drain groove 22P would not be blocked by the presence of pot chin 23B (FIG. 6). The formation of drain grooves 22P on the inside surface of pot receiver 22C can make the wall of pot receiver 22C and terrace 22L thin or breakable due to the presence of drain grooves 22P. In order to solve this problem, the outer surface of the wall of pot receiver 22C and the underside of terrace 22L are molehilled (not shown in FIG. 7) along and opposite the drain groove 22P. A molehill structure is to reinforce or thicken the wall over a shallow tunnel or beneath a groove.

Referring to FIGS. 6 and 7, the upper portion of pot receiver 22C is connected to terrace 22L, which is slightly sloped to help drainage. Terrace 22L is connected to terrace ridge 22K, which is connected to the top portion of shell 22D.

Referring to FIG. 6, terrace space 22M is the space between terrace ridge 22K and the exterior side of pot shoulder 23A. Space 22M is about 15 mm. But the dimension of space 22M can vary in other embodiments.

Referring to FIGS. 1 to 3, pot supporter 22 is paired with corresponding pot 23 of predetermined shape and dimension. Pot supporter 22 and pot 23 can come in various shapes and sizes.

Referring to FIG. 6, pot 23 has shoulder 23A, chin 23B, and side 23C. Chin 23B is designed to sit on the edge of terrace 22L. Pot 23 of the present invention is not much different from conventional pots with top-broad-and-bottom-narrow shape, except that pot 23 has a predetermined shape and dimension to fit pot receiver 22C. Consumers may place any conventional pot of approximately the right size and right shape in pot receiver 22C. But such a practice is not recommended because conventional pots will not perfectly fit receiver 22C due to the specific dimension and shape of receiver 22C. When pot 23 of the right size and right shape is held in corresponding receiver 22C, pot 23 will not sway in receiver 22C, and the top edge of pot 23 will be leveled with or a little lower than the top edge of shell 22D (as shown in FIG. 1), and the bottom of pot 23 will lightly rest on saucer 24. But in other embodiments, the top edge of pot 23 can be higher than the tope edge of shell 22D, and the bottom of pot 23 does not make contact with saucer 24.

Referring to FIGS. 2, 3, 4, and 5, shell 22D has three aeration holes 22E of oval shape that are equidistantly positioned around the wall of shell 22D. in other embodiments, the number of holes 22E can be other than three, and the shape of hole 22E can be other than oval.

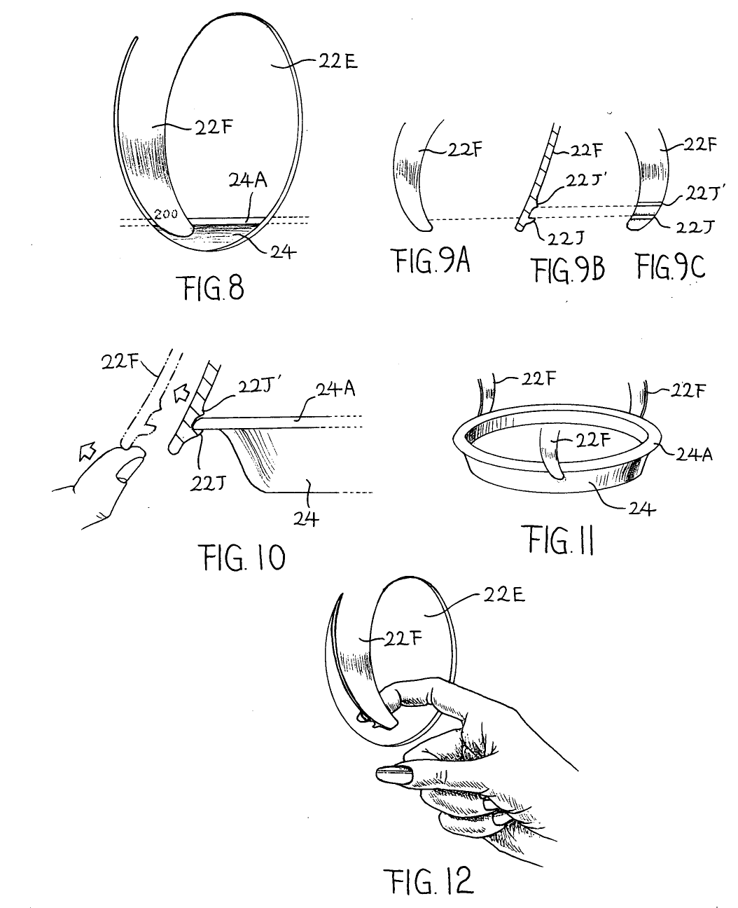

On the left side of each aeration hole 22E is a longitudinal member or saucer holder 22F of predetermined shape and dimension. Each saucer holder 22F, which is the part of the wall of shell 22D, is of a vertical crescent shape and is defined by the slit or space (aeration hole 22E) that surrounds saucer holder 22F with the upper portion of saucer holder 22F being connected to the wall of shell 22D. The lower portion of saucer holder 22F can be pulled outward when pulled gently with a finger (or other hooked object), as shown in FIGS. 10 and 12. In other embodiments, the shape of saucer holders 22F can be other than a crescent, and the position of saucer holder 22F within aeration hole 22E can vary. FIGS. 13A, 13B, and 13C show several variations of aeration holes (22E′, 22E″, and 22E′″) and saucer holders (not numbered). There can be additional aeration holes 22T (FIG. 13C) of any shape or dimension or number on any part of shell 22D.

Referring to FIGS. 9B, 9C, and 10, each of saucer holders 22F has a pair of saucer-rim-holding projections, i.e., upper projection 22J′ and lower projection 22J, on the lower, interior side of saucer holder 22F. The shape, dimension, and configuration of projections 22J and 22J′ are predetermined so that the edge of saucer rim 24A can be removably anchored between projections 22J and 22J′, as shown in FIG. 10. In this way, saucer 24 can be horizontally and removably secured in the predetermined position in the interior region of shell 22D due to the combined anchorage of the projections on three saucer holders 22F, as shown in FIG. 11.

Referring to FIG. 1, saucer 24 is removably secured in the interior region of shell 22D in suspension. That is, the bottom of saucer 24 does not make contact with the surface (not numbered in FIG. 1) upon which pot supporter 22 is placed. The space between the bottom of saucer 24 and the surface upon which pot supporter 22 is placed is about 25 mm. But the dimension of the space can vary in other embodiments.

Referring to FIG. 1, the depth of saucer 24 is about 25 mm. But the depth of saucer 24 can vary in other embodiments. A user may place small rocks or weighty objects in saucer 24, as shown in FIG. 1, to attain extra stability or balance of pot 23 being held in pot supporter 22.

Pot supporter 22, corresponding pot 23, and corresponding saucer 24 can come in various sizes. The size of pot 23 shall be classified by the diameter of the upper portion of pot 23. For example, the size of pot 23 whose diameter of top portion is 100 mm is 100. The size of pot supporter 22 shall be classified by the size of corresponding pot 23 that is to be paired with pot supporter 22. For example, a pot supporter for a corresponding pot of size 100 is size 100. It is recommended that the size of a pot supporter is denoted in relief or intaglio, for example, on the upper, outer side of shell 22D, and the size of a corresponding pot is denoted on the outer side of pot shoulder (23A).

The size of saucer 24 shall be classified by the dimension of the diameter of rim 24A (FIGS. 10, 11). For example, the size of saucer 24 whose rim diameter is 200 mm is 200. In order to help users match their pot supporters with the right-sized saucers, it is recommended that the saucer size is denoted on the upper surface of the saucer rim. The size of the right-sized saucer can be denoted on the outside of each saucer holder 22F of corresponding pot supporter 22, as shown in FIG. 8. (See the number “200” denoted on the outside of saucer holder 22F.)

Referring to FIGS. 13A to 13C, pot supporter 22 of a size can come in various different heights, e.g., low style, as shown in 13A (shell 22D′), or medium style, as shown in FIG. 13B (shell 22D″), or high style, as shown FIG. 13C (shell 22D′″) to meet the various growing habits or shapes of plants. For example, a pot supporter with a low-height-and-broad-bottom shell, as shown in FIG. 13A (22D′), may be good for the plants that grow tall or spread horizontally. A pot supporter with a tall shell, as shown in FIG. 13C (22D′″), may be good for the plants that weep or cascade.

Referring to FIGS. 1 and 2, the outer line of shell 22D in an elevational view is a concave curve. But in other embodiments, the outer line of shell 22D can be other than concave curve, e.g., straight line, convex curve, irregular line, etc.

Referring to FIGS. 3 and 5, hanger holes 22A are equidistantly positioned around the upper portion of shell 22D. The user may fasten wires, strings, or any type of pot hangers to hanger holes 22A to carry or hang pot supporter 22 with pot 23 therein when necessary. The number of hanger holes 22A is three, the shape of hanger hole 22A is round, and the diameter of hanger hole 22A is about 5 mm. But the number, shape, and dimension of hanger holes 22A can vary in other embodiments.

Referring to FIGS. 3 and 5, the top views of shell 22D, pot receiver 22C, pot 23, and saucer 24 are round. But in other embodiments, the top views of these components can be other than round, e.g., square, rectangular, polygonal, oval, etc. However, regardless of the shape of the top views of these components, it is recommended that the number of saucer holders 22F remain three. But the number of saucer holders 22F can vary in other embodiments.

Referring to FIGS. 1 and 3, pot supporter 22, pot 23, and saucer 24 are composed of rigid yet flexible material such as plastic, acrylics, fiberglass, etc. It is recommended that the outer surface of shell 22D be matte or of high gloss finish with light or mid-tone color. Any attractive colors, patterns, images, or texture can be added on the outer surface of shell 22D for the embellishment effect.

Pot supporter 22, pot 23, and saucer 24 can be made of transparent material in an embodiment. Such transparency itself can be an attractive element, and that kind of embodiment can be used as a demonstrative model to show customers the parts and functions of the components of the present invention without words.

Referring to FIG. 14A, the stable flowerpot system further includes pot-supporter skirt 26 as a decorative component. Skirt 26 is fabricated from fabric, lace, vinyl, plastic, paper, etc., or any combination thereof, and of various designs and colors.

Referring to FIGS. 15 to 17, pot-supporter skirt 26 has six skirt-holding eyes 26G that are equidistantly positioned around the inner, lower part of skirt 26. Skirt-holding eye 26G is made of elastic or non-elastic material. Skirt-holding eyes 26G are to be hooked to corresponding skirt holders 22U on the bottom edge of shell 22D, as shown in FIG. 17. Skirt holders 22U are equidistantly positioned around the bottom edge of shell 22D, as shown in FIG. 5. The number of skirt-holding eyes 26G (FIG. 15) on skirt 26 is six, and the number of corresponding skirt holders 22U (FIG. 5) on shell 22D are also six. But, in other embodiments, the number of skirt-holding eyes 26G and the number of skirt holders 22U can vary from zero to many. If there are no skirt-holding eyes 26G on skirt 26, the hem or lower portion of skirt 26 is loosely draped around the lower potion of shell 22D.

Referring to FIGS. 19A to 19C, pot-supporter skirt 26 comprises six gores 26A, six seams 26D, six seam covers 26E, upper band 26B, upper-band lining 26C, and lower band 26F. But the number of gores 26A, the number of seams 26D, and the number of seam covers 26E can vary in other embodiments. Band lining 26C is made of spandex or other elastic material. The surface of band lining 26C is coated (not shown) with rubber or similar material thereon so that lining 26C can securely grip the upper, exterior side of pot supporter 22. Seem covers 26E can contain elastic plastic strips (not shown) therein to make gores 26A stiff and taut. Decorative skirt 26 can be fully lined (not shown) below band lining 26C.

Pot-supporter skirt 26 is configured with a pullover style so that skirt 26 can be pulled over shell 22D. But in other embodiments, skirt 26 is of zipper-style (not shown) preferably with invisible nylon zipper. Pot-supporter skirt 26 can come in large variety of designs, colors, and materials with additional means of embellishments such as ruffles, tiers, pleats, fringes, patterns, embroidery, ribbons, beads, glitter, etc. Skirt 26 in FIG. 14A, skirt 26′ in FIG. 14B, and skirt 26″ in FIG. 14C are only a few examples of many possible embodiments.

Referring to FIG. 14C, the stable flowerpot system further includes pot-supporter cushion 27 to be placed under pot supporter 22. Cushion 27 is made of fabric, lace, vinyl, plastic, paper, etc., or any combination thereof, and of various additional means of embellishment. Cushion 27 is to embellish pot 23 with or without decorative skirt 26. The underside of cushion 27 can be lightly coated with rubber or rubber-like material to prevent the slippage of pot supporter 22.

The top views of pot-supporter skirt 26 and cushion 27 is round. But in other embodiments, the top views of skirt 26 and cushion 27 can be oval, square, rectangular, polygonal, jagged, etc. Preferably, skirt 26 and cushion 27 come as a set with matching color, design, and material. It is recommended that the design or embellishment of skirt 26 and cushion 27 not be overdone lest the embellishment effect of skirt 26 and cushion 27 makes the plant being held in the pot relatively inconspicuous.

### Operation

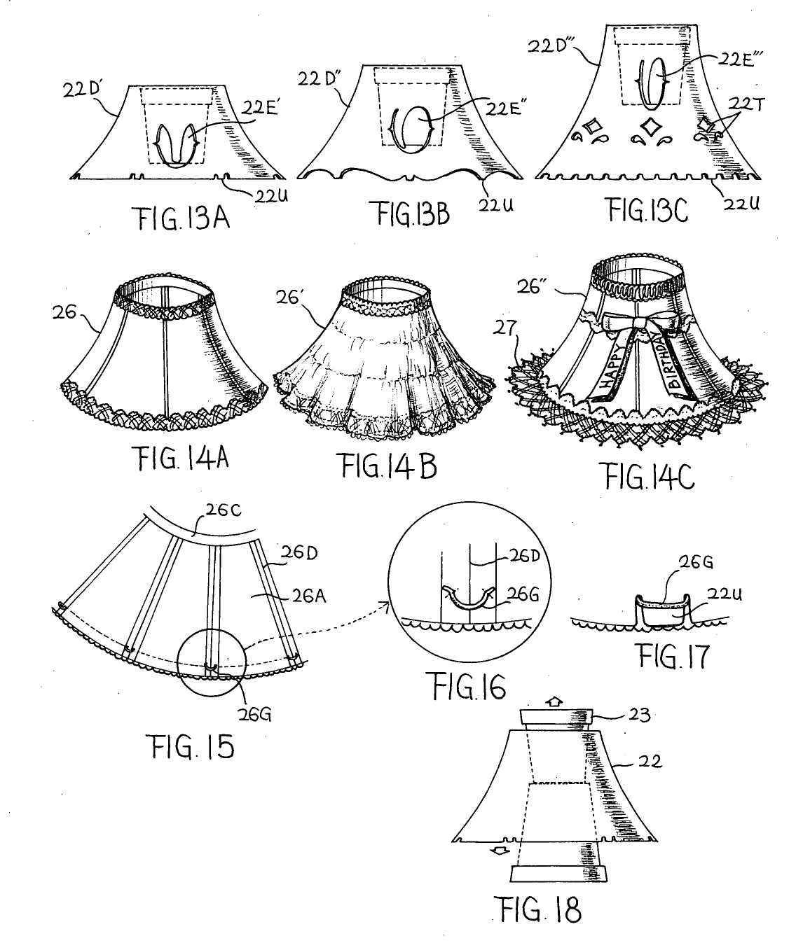

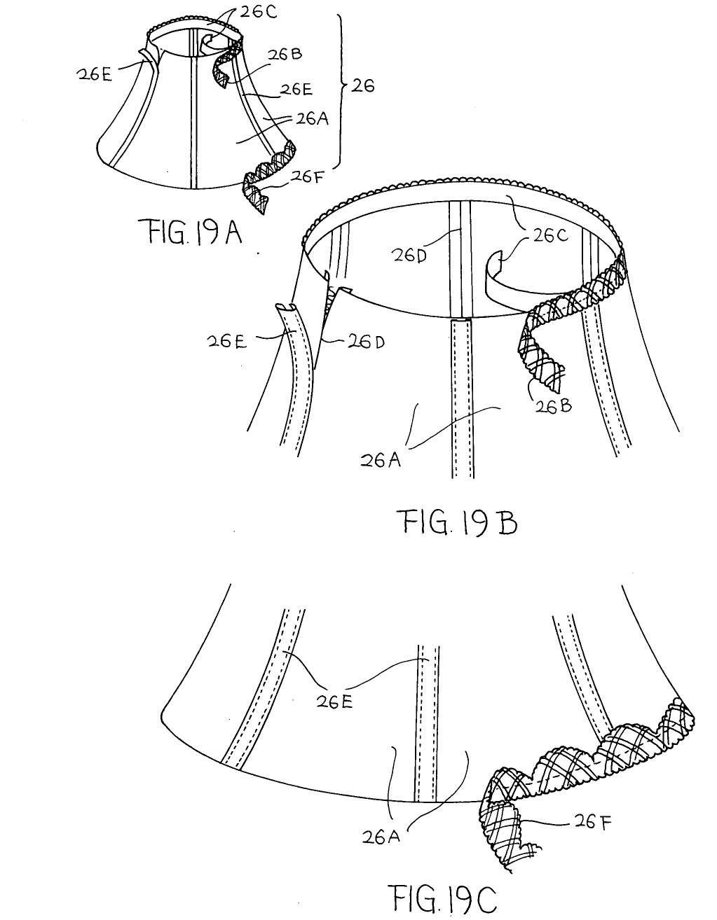

In order to use the stable flowerpot system of the present invention, a user inserts pot 23 in pot receiver 22C of corresponding pot supporter 22 as shown in FIG. 1. The user can remove pot 23 from pot supporter 22 by taking a hold on the upper edge of pot 23 and then pulling out pot 23 from receiver 22C. If pot 23 is stuck fast in receiver 22C, the user can remove pot 23 from receiver 22C as illustrated in FIG. 18. Specifically, the user places pot supporter 22 (with pot 23 therein) on top of another pot (not numbered in FIG. 18) that is in upside-down position, and then push down pot supporter 22 until pot 23 emerges from pot supporter 22.

If the user wants to insert saucer 24 into the interior region of pot supporter 22, the user places saucer 24 on top of an upside-down pot or similar object, and places pot supporter 22 over saucer 24, and push pot supporter 22 downward with gentle force, maintaining upright position of pot supporter 22, until the rim of saucer 24 is snap-locked into saucer-rim-holding projections 22J and 22J′ on saucer holders 22F as shown in FIG. 10. If saucer 24 is secured in the interior region of shell 22 D, as shown in FIG. 1, saucer 24 works as a buttress for shell 22D. That is, saucer 24 helps shell 22D maintain its given shape.

If the user wants to separate saucer 24 from pot supporter 22, the user places pot supporter 22 (with saucer 24 therein) on a level surface, and pulls the lower tips or lower portions of saucer holders 22F outward a bit, one by one, using user's finger (or other hooked object) as shown in FIGS. 10 and 12.

If the user wants to embellish pot 23 (being held in supporter 22) with decorative skirt 26, the user pulls skirt 26 over shell 22D before the user inserts pot 23 in pot receiver 22C. Next, the user fastens skirt-holding eyes 26G to corresponding skirt holders 22U, as shown in FIG. 17. If the user wants to place pot-supporter cushion 27 under pot supporter 22, the user simply places cushion 27 under pot supporter 22.

### Advantages

Several advantages of the stable flowerpot system are as follows.

(a) The stable flowerpot system is configured not to fall easily, even when it holds an unbalanced or top-heavy plant. Therefore, a user can prevent flowers, buds, leaves, other parts of the plant, and pot medium from being damaged or lost due to the falling of pots.

(b) A user can achieve further stability or balance of the pot being held in the stable flowerpot system by placing some pebbles, rocks, or other weighty objects in the saucer that is removably secured in the interior region of the shell of the pot supporter.

(c) The user of the stable flowerpot system can enjoy a wide variety of postures or growth of plants without worrying about the toppling over of the pots.

(d) The appearance, i.e. the design, structure, color, etc., of the pot supporter can provide an embellishment effect to the pot.

(e) The user can further embellish the pot with a matching decorative pot-supporter skirt and/or a pot-supporter cushion for the formal or informal display of the pot.

(f) The flowerpot system can be hung or carried readily if the user attaches wires, strings, or any type of pot hangers to the hanger holes on the top portion of the pot supporter.

(g) The components of the stable flowerpot system can be manufactured, purchased, or replaced separately when necessary.

(h) The components of the stable flowerpot system can be reused many times, which is economical and environmentally friendly. To achieve this object, it is recommended that the components of the present invention meet a certain standard of strength and durability.

The main scope of the stable flowerpot system of the present invention is to provide sufficient stability to the pot being held in the system so as to prevent the pot being held in the system from falling or toppling over, even when the pot contains a top-heavy or unbalanced plant. However, the decorative effect of the pot supporter, pot-supporter skirt and cushion are not less important. Although the description above contains many specifics, these should not be construed as limiting the scope of the invention but as merely providing illustrations of some of the preferred embodiments of the present invention.

I claim:

1. A device for holding at least one plant comprising:
a pot supporter having a hollow shell whose bottom portion is broader than the top portion of said shell with said top portion of said shell being extended in-and-downwardly into the interior region of said hollow shell to form a pot receiver.
a corresponding pot whose shape and dimension are predetermined to be removably secured in said pot receiver in said interior region of said shell of said pot supporter,
whereby said pot being held in said pot receiver of said pot supporter will not fall easily even when said pot holds a top heavy or unbalanced plant.

2. The device for holding at least one plant of claim 1, wherein said pot supporter and said pot are composed of rigid yet flexible material.

3. The device for holding an ornamental plant of claim 1 further comprising a corresponding saucer whose shape and dimension are predetermined to be placed in a predetermined position in the interior region of said shell of said pot supporter.

4. The device for holding an ornamental plant of claim 3, wherein said saucer is composed of rigid yet flexible material.

5. The device for holding an ornamental plant of claim 1, wherein said shell comprises a plurality of longitudinal members formed on the wall of said shell; each of said members has a predetermined shape, dimension, and position on said wall of said shell with the upper portion of said member being connected to said wall of said shell, and the remaining part of said member being separated from said wall of said shell by the slit or opening formed around said member, and a pair of projections of predetermined shape, dimension, and configuration is formed on the lower, interior side of each of said members, so that the edge of the rim of said saucer placed in said predetermined position in said interior region of said shell can be removably anchored between said pair of projections on said member in such a manner that said saucer can be horizontally and removably secured in said interior region of said shell due to the combined anchorage of said projections on said members on said wall of said shell.

6. The device for holding an ornamental plant of claim 1 further including a decorative skirt that is configured to be clad on the outside of said shell for the decoration of said pot being held in said pot receiver of said pot supporter.

7. The device for holding an ornamental plant of claim 6, wherein said skirt is fabricated from material selected from the group of materials consisting of fabric, lace, vinyl, plastic, paper, or any combination thereof.

8. The device for holding an ornamental plant of claim 7 further including a decorative cushion that is configured to be placed under said shell for the decoration of said pot being held in said receiver of said pot supporter.

9. The device for holding an ornamental plant of claim 8, wherein said cushion is fabricated from material selected from the group of materials consisting of fabric, lace, vinyl, plastic, paper, or any combination thereof.
